(19) United States
(12) Patent Application Publication
(10) Pub. No.: US 2024/0309199 A1
(43) Pub. Date: Sep. 19, 2024

(54) Thermoplastic Resin Composition and Molded Article Manufactured Therefrom

(71) Applicant: LOTTE CHEMICAL CORPORATION, Seoul (KR)

(72) Inventors: Sanghyun HONG, Uiwang-si (KR); Hanna KIM, Uiwang-si (KR); Kyunha BAN, Uiwang-si (KR); Bongjun SONG, Uiwang-si (KR)

(21) Appl. No.: 18/574,458

(22) PCT Filed: Jun. 28, 2022
(86) PCT No.: PCT/KR2022/009181

§ 371 Date: Dec. 27, 2023

(30) Foreign Application Priority Data
Jun. 30, 2021 (KR) 10-2021-0086130

(51) Int. Cl. C08L 51/04; C08K 5/098

(52) U.S. Cl. CPC C08L 51/04; C08K 5/098; C08L 2203/30; C08L 2205/025; C08L 2205/035; C08L 2207/53

(57) ABSTRACT

The present invention relates to a thermoplastic resin composition and a molded article manufactured therefrom, wherein the thermoplastic resin composition comprises: on the basis of 100 parts by weight of a base resin including (A) 70 to 95 weight % of a butadiene-based rubber-modified aromatic vinyl-vinyl cyanide copolymer resin and (B) 5 to 30 weight % of a polyamide resin, (C) 3 to 15 parts by weight of a polyetheresterimide block copolymer, (D) 1 to 10 part by weight of a maleic anhydride-aromatic vinyl-vinyl cyanide copolymer, and (E) 0.1 to 1 part by weight of calcium stearate.

### TECHNICAL FIELD

The present invention relates to a thermoplastic resin composition and a molded article manufactured therefrom.

### BACKGROUND ART

Styrene resins, represented by acrylonitrile-butadiene-styrene copolymer (ABS) resins, are widely used in a variety of applications owing to good properties thereof in terms of moldability, mechanical properties, appearance, secondary processability, and the like.

Molded articles produced from styrene resins can be applied to a wide range of products, such as various interior/exterior materials for automobiles and/or electronic devices, which require painting/non-painting.

In particular, painting is sometimes performed on molded articles produced from the styrene resins to impart aesthetic effects to various interior/exterior materials. Although a painting method is not particularly limited, electrostatic painting is generally used in the art. Such electrostatic painting is a method of imparting electrical conductivity to a surface of a molded article, followed by painting the molded article. In general, in order to apply electrostatic painting to a plastic molded article with high surface resistance, it is necessary to perform pretreatment on the surface of the molded article using, for example, a conductive primer.

Since application of the conductive primer increases the number of processes and manufacturing time, it has recently been proposed to further add various conductive materials (e.g., carbon nanotubes and the like) and/or additives for expression of conductivity to a styrene resin such that a molded article produced from the styrene resin can exhibit a certain level of inherent electrical conductivity.

However, when the conductive materials and/or the additives for expression of conductivity are added to the styrene resin, there is a concern of damage to property balance of the styrene resin, causing unexpected degradation in various properties.

Therefore, there is a need to develop a thermoplastic resin composition with good properties that enables electrostatic painting without application of a conductive primer.

### DISCLOSURE

### Technical Problem

It is one aspect of the present invention to provide a thermoplastic resin composition that exhibits good electrical conductivity to enable electrostatic painting without application of a conductive primer and secures good paint adhesion without a blistering phenomenon even when exposed to a harsh environment of high temperature/high humidity for a long period of time after electrostatic painting, and a molded article manufactured therefrom.

### Technical Solution

1. In accordance with one aspect of the present invention, a thermoplastic resin composition comprises: relative to 100 parts by weight of a base resin comprising 70 to 95 wt % of (A) a butadiene rubber modified aromatic vinyl-vinyl cyanide copolymer resin and 5 to 30 wt % of (B) a polyamide resin; 3 to 15 parts by weight of (C) a polyether-ester-amide block copolymer; 1 to 10 parts by weight of (D) a maleic anhydride-aromatic vinyl-vinyl cyanide copolymer; and 0.1 to 1 part by weight of (E) calcium stearate.

The (A) butadiene rubber modified aromatic vinyl-vinyl cyanide copolymer resin may comprise: a butadiene rubber modified aromatic vinyl-vinyl cyanide copolymer dispersed phase having a core-shell structure in which a core is composed of a butadiene rubber polymer and a shell is formed by graft polymerization of an aromatic vinyl compound and a vinyl cyanide compound to the core; and an aromatic vinyl-vinyl cyanide copolymer continuous phase, and the butadiene rubber polymer may have an average particle diameter of 0.2 μm to 1.0 μm.

The (A) butadiene rubber modified aromatic vinyl-vinyl cyanide copolymer resin may comprise 10 to 40 wt % of the butadiene rubber modified aromatic vinyl- vinyl cyanide copolymer dispersed phase and 60 to 90 wt % of the aromatic vinyl- vinyl cyanide copolymer continuous phase, based on 100 wt % of the (A) butadiene rubber modified aromatic vinyl-vinyl cyanide copolymer resin.

In the (A) butadiene rubber modified aromatic vinyl-vinyl cyanide copolymer resin, the aromatic vinyl-vinyl cyanide copolymer may comprise 60 to 80 wt % of an aromatic vinyl compound-derived component and 20 to 40 wt % of a vinyl cyanide compound-derived component.

The (A) butadiene rubber modified aromatic vinyl-vinyl cyanide copolymer resin may be an acrylonitrile-butadiene-styrene copolymer resin comprising an acrylonitrile-butadiene-styrene graft copolymer dispersed phase and an acrylonitrile- styrene copolymer continuous phase.

The (B) polyamide resin may comprise polyamide 6, polyamide 66, polyamide 46, polyamide 11, polyamide 12, polyamide 610, polyamide 612, polyamide 6I, polyamide 6T, polyamide 4T, polyamide 410, polyamide 510, polyamide 1010, polyamide 1012, polyamide 10T, polyamide 1212, polyamide 12T, polyamide MXD6, or a combination thereof.

The (B) polyamide resin may comprise polyamide 6.

The (C) polyether-ester-amide block copolymer may be a reaction product of an aminocarboxylic acid having 6 or more carbon atoms, a lactam, or a salt of diamine-dicarboxylic acid; a polyalkylene glycol; and a dicarboxylic acid having 4 to 20 carbon atoms.

The (D) maleic anhydride-aromatic vinyl-vinyl cyanide copolymer may comprise 2 to 15 wt % of a maleic anhydride-derived component based on 100 wt %.

The (D) maleic anhydride-aromatic vinyl-vinyl cyanide copolymer may be a maleic anhydride-styrene-acrylonitrile copolymer.

The (E) calcium stearate may be present in an amount of 0.2 to 0.7 parts by weight relative to 100 parts by weight of the base resin.

The thermoplastic composition may further comprise at least one additive selected from among a nucleating agent, a coupling agent, a filler, a plasticizer, a lubricant, a release agent, an antibacterial agent, a heat stabilizer, an antioxidant, an ultraviolet stabilizer, a flame retardant, a colorant, and an impact modifier.

In accordance with another aspect of the present invention, a molded article manufactured from the thermoplastic resin composition is provided.

The molded article may have a notched Izod impact strength of 20 to 60 kgf·cm/cm, as measured on a ¼″ thick specimen in accordance with ASTM D256.

The molded article may have a surface resistance of 10^{11.0} Ω/sq or less, as measured on a specimen having a size 100 mm×100 mm×20 mm using a surface resistance meter (Manufacturer: SIMCO-ION, Model: ST-4).

### Advantageous Effects

A thermoplastic resin composition according to embodiments of the present invention and a molded article using the same exhibit good electrical conductivity and property balance, particularly good paint adhesion without a blistering phenomenon even when exposed to a harsh environment of high temperature/high humidity for a long period of time after electrostatic painting, and can be widely applied to various products used for painting and non-painting, particularly to molded articles for painting that require electrostatic painting.

### DESCRIPTION OF DRAWINGS

FIG. 1 is a picture for evaluation of a blistering phenomenon of a molded article of Example 1.

FIG. 2 is a picture for evaluation of a blistering phenomenon of a molded article of Comparative Example 1.

FIG. 3 is a picture for evaluation of paint adhesion of a molded article of Example 1.

FIG. 4 is a picture for evaluation of paint adhesion of a molded article of Comparative Example 1.

### BEST MODE

Hereinafter, exemplary embodiments of the present invention will be described in detail. However, it should be understood that these embodiments are provided by way of example and the present invention is defined only by the appended claims.

Unless otherwise specified, an average particle size of a rubber polymer refers to an volume average diameter and a Z-average particle size, as measured using a dynamic light scattering analyzer.

According to one embodiment, there is provided a thermoplastic resin composition comprising: relative to 100 parts by weight of a base resin comprising 70 to 95 wt % of (A) a butadiene rubber modified aromatic vinyl-vinyl cyanide copolymer resin and 5 to 30 wt % of (B) a polyamide resin; 3 to 15 parts by weight of (C) a polyether-ester-amide block copolymer; 1 to 10 parts by weight of (D) a maleic anhydride-aromatic vinyl-vinyl cyanide copolymer; and 0.1 to 1 part by weight of (E) calcium stearate.

Hereinafter, each component of the thermoplastic composition will be described in detail.

### (A) Butadiene Rubber Modified Aromatic Vinyl-Vinyl Cyanide Copolymer Resin

In one embodiment, the (A) butadiene rubber modified aromatic vinyl-vinyl cyanide copolymer resin imparts good impact resistance and fluidity to the thermoplastic resin composition.

In one embodiment, the butadiene rubber modified aromatic vinyl-vinyl cyanide copolymer resin may comprise a butadiene rubber modified aromatic vinyl-vinyl cyanide copolymer dispersed phase having a core-shell structure in which a core is composed of a butadiene rubber polymer and a shell is formed by graft polymerization of an aromatic vinyl compound and a vinyl cyanide compound to the core, and an aromatic vinyl-vinyl cyanide copolymer continuous phase.

The (A) butadiene rubber modified aromatic vinyl-vinyl cyanide copolymer resin may comprise 10 to 40 wt %, for example, 10 to 30 wt %, for example, 20 to 30 wt %, of the butadiene rubber modified aromatic vinyl-vinyl cyanide copolymer dispersed phase, and 60 to 90 wt %, for example, 70 to 90 wt %, for example, 70 to 80 wt %, of the aromatic vinyl-vinyl cyanide copolymer continuous phase, based on 100 wt % of the (A) butadiene rubber modified aromatic vinyl-vinyl cyanide copolymer resin. Within this range, the thermoplastic resin composition can exhibit good impact resistance and fluidity.

The butadiene-based rubber modified aromatic vinyl-vinyl cyanide graft copolymer according to one embodiment may be prepared by adding an aromatic vinyl compound and a vinyl cyanide compound to a butadiene rubber polymer, followed by graft polymerization by a typical polymerization method, such as emulsion polymerization, bulk polymerization, and the like.

The butadiene rubber polymer may be selected from the group consisting of a butadiene rubber polymer, a butadiene-styrene rubber polymer, a butadiene- acrylonitrile rubber polymer, a butadiene-acrylate rubber polymer, and mixtures thereof.

The aromatic vinyl compound may be selected from the group consisting of styrene, α-methyl styrene, p-methyl styrene, p-t-butyl styrene, 2,4-dimethyl styrene, chlorostyrene, vinyl toluene, vinyl naphthalene, and mixtures thereof.

The vinyl cyanide compound may be selected from the group consisting of acrylonitrile, methacrylonitrile, fumaronitrile, and mixtures thereof.

The butadiene rubber polymer may have an average particle diameter of 0.2 μm to 1.0 μm, for example, 0.2 μm to 0.8 μm, for example, 0.25 μm to 0.40 μm. Within this range, the thermoplastic resin composition can exhibit good impact resistance and appearance properties.

The butadiene rubber polymer may be present in an amount of 40 to 70 wt %, for example, 40 to 60 wt %, for example, 50 to 60 wt %, based on 100 wt % of the butadiene rubber modified aromatic vinyl-vinyl cyanide graft copolymer. On the other hand, the aromatic vinyl compound and the vinyl cyanide compound graft polymerized to the core composed of the butadiene rubber polymer may be present in a weight ratio of 6:4 to 8:2.

In one embodiment, the butadiene-based rubber modified aromatic vinyl- cyanide graft copolymer may be an acrylonitrile-butadiene-styrene graft copolymer.

The aromatic vinyl-vinyl cyanide copolymer may be prepared through copolymerization of a monomer mixture comprising an aromatic vinyl compound and a vinyl cyanide compound by a typical polymerization method, such as suspension polymerization, bulk polymerization, and the like.

The aromatic vinyl compound may be selected from the group consisting of styrene, α-methyl styrene, p-methyl styrene, p-t-butyl styrene, 2,4-dimethyl styrene, chlorostyrene, vinyl toluene, vinyl naphthalene, and mixtures thereof.

The vinyl cyanide compound may be selected from the group consisting of acrylonitrile, methacrylonitrile, fumaronitrile, and mixtures thereof.

The aromatic vinyl-vinyl cyanide copolymer may comprise 60 to 80 wt %, for example, 60 to 75 wt %, for example, 65 to 75 wt %, of an aromatic vinyl compound-derived component, and 20 to 40 wt %, for example, 25 to 40 wt %, for example, 25 to 35 wt %, of a vinyl cyanide compound-derived component.

The aromatic vinyl-vinyl cyanide copolymer may have a weight average molecular weight of 80,000 to 300,000 g/mol, for example, 80,000 to 250,000 g/mol, for example, 80,000 to 200,000 g/mol, for example, 80,000 to 150,000 g/mol, for example, 100,000 to 150,000 g/mol.

In one embodiment, the aromatic vinyl-vinyl cyanide copolymer may be an acrylonitrile-butadiene-styrene copolymer.

In one embodiment, the (A) butadiene rubber modified aromatic vinyl-vinyl cyanide copolymer resin may be an acrylonitrile-butadiene-styrene copolymer resin comprising an acrylonitrile-butadiene-styrene graft copolymer dispersed phase and an acrylonitrile-styrene copolymer continuous phase.

The (A) butadiene rubber modified aromatic vinyl-vinyl cyanide copolymer resin may be present in an amount of 70 to 95 wt %, for example, 75 to 95 wt %, for example, 80 to 95 wt %, for example, 80 to 90 wt %, for example, 80 to 85 wt %, based on 100 wt % of the base resin. Within these ranges, the thermoplastic resin composition can have good properties in terms of impact resistance, fluidity, and property balance.

### (B) Polyamide Resin

In one embodiment, the polyamide resin allows the thermoplastic resin composition to exhibit good electrical conductivity even without an excess of the (C) polyether-ester-amide block copolymer described below.

In one embodiment, the polyamide resin may be selected from various polyamide resins known to those skilled in the art and may include, for example, an aromatic polyamide resin, an aliphatic polyamide resin, or a mixture thereof, without being limited thereto.

The aromatic polyamide resin is a polyamide having an aromatic group in a main chain and may be a total-aromatic polyamide, a semi-aromatic polyamide, or a mixture thereof.

The total-aromatic polyamide means a polymer of an aromatic diamine and an aromatic dicarboxylic acid, and the semi-aromatic polyamide means an aromatic polyamide containing at least one aromatic unit and at least one non-aromatic unit between amide bonds. For example, the semi-aromatic polyamide may be a polymer of an aromatic diamine and an aliphatic dicarboxylic acid or a polymer of an aliphatic diamine and an aromatic dicarboxylic acid.

The aliphatic polyamide means a polymer of an aliphatic diamine and an aliphatic dicarboxylic acid.

The aromatic diamine may include, for example, p-xylene diamine, m-xylene diamine, and the like, without being limited thereto. These may be used alone or as a mixture thereof.

The aromatic dicarboxylic acid may include, for example, phthalic acid, isophthalic acid, terephthalic acid, 2,6-naphthalenedicarboxylic acid, (1,3-phenylenedioxy)diacetic acid, and the like, without being limited thereto. These may be used alone or as a mixture thereof.

The aliphatic diamine may include, for example, ethylenediamine, trimethylenediamine, hexamethylenediamine, dodecamethylenediamine, piperazine, and the like, without being limited thereto. These may be used alone or as a mixture thereof.

The aliphatic dicarboxylic acid may include, for example, adipic acid, sebacic acid, succinic acid, glutaric acid, azelaic acid, dodecanedioic acid, dimeric acid, cyclohexanedicarboxylic acid, and the like, without being limited thereto. These may be used alone or as a mixture thereof.

In one embodiment, the polyamide resin may comprise polyamide 6, polyamide 66, polyamide 46, polyamide 11, polyamide 12, polyamide 610, polyamide 612, polyamide 6I, polyamide 6T, polyamide 4T, polyamide 410, polyamide 510, polyamide 1010, polyamide 1012, polyamide 10T, polyamide 1212, polyamide 12T, polyamide MXD6, or a combination thereof.

In one embodiment, the (B) polyamide resin may comprise polyamide 6.

In one embodiment, the polyamide resin may be present in an amount of 5 to 30 wt %, for example, 5 to 25 wt %, for example, 5 to 20 wt %, for example, 10 to 20 wt %, for example, 15 to 20 wt %, based on 100 wt % of the base resin.

Within this range of the polyamide resin, the thermoplastic resins composition and a molded product manufactured therefrom can exhibit good properties in terms of roughness, toughness, wear resistance, chemical resistance, oil resistance, and the like.

### (C) Polyether-Ester-Amide Block Copolymer

In one embodiment, the (C) polyether-ester-amide block copolymer allows the thermoplastic resin composition and a molded product manufactured therefrom to exhibit electrical conductivity.

In addition, the (C) polyether-ester-amide block copolymer allows the thermoplastic resin composition and a molded product manufactured therefrom to exhibit such electrical conductivity while maintaining good property balance.

In one embodiment, the (C) polyether-ester-amide block copolymer may be, for example, a reaction mixture of an aminocarboxylic acid having 6 or more carbon atoms, a lactam, or a salt of diamine-dicarboxylic acid; a polyalkylene glycol; and a dicarboxylic acid having 4 to 20 carbon atoms.

In one embodiment, the aminocarboxylic acid having 6 or more carbon atoms may include aminocarboxylic acids, such as ω-aminocaproic acid, ω-aminoenanthic acid, ω-aminocaprylic acid, ω-aminopelargonic acid, ω-aminocapric acid, 11-aminoundecanoic acid, 12-aminododecanoic acid, and the like; the lactam may include lactams, such as ε-caprolactam, enantolactam, capryl lactam, laurolactam, and the like; and the salt of diamine-dicarboxylic acid may include salts of diamines and dicarboxylic acids, such as salts of hexamethylenediamine-adipic acid, salts of hexamethylenediamine-isophthalic acid, and the like. For example, 12-aminododecanoic acid, ε-caprolactam, and salts of hexamethylenediamine-adipic acid, and the like may be used as the aminocarboxylic acid having 6 or more carbon atoms, the lactam, and the salt of diamine-dicarboxylic acid.

In one embodiment, the polyalkylene glycol may include polyethylene glycol, polypropylene glycol, polytetramethylene glycol, polyhexamethylene glycol, a block or random copolymer of ethylene glycol and propylene glycol, a copolymer of ethylene glycol and tetrahydrofuran, and the like. For example, polyethylene glycol, a copolymer of ethylene glycol and propylene glycol, and the like may be used.

In one embodiment, the dicarboxylic acid having 4 to 20 carbon atoms may include terephthalic acid, 1,4-cyclohexanedicarboxylic acid, sebacic acid, adipic acid, dodecanedioic acid, and the like.

A bond between the aminocarboxylic acid having 6 or more carbon atoms, the lactam, or the salt of the diamine-dicarboxylic acid and the polyalkylene glycol may be an ester bond; a bond between the aminocarboxylic acid having 6 or more carbon atoms, the lactam, or the salt of the diamine-dicarboxylic acid and the dicarboxylic acid having 4 to 20 carbon atoms may be an amide bond; and a bond between the polyalkylene glycol and the dicarboxylic acid having 4 to 20 carbon atoms may be an ester bond.

In one embodiment, the (C) polyether-ester-amide block copolymer may be prepared by a method well-known in the art, for example, by a method disclosed in JP Patent Publication No. S56-045419 or JP Unexamined Patent Publication No. S55-133424.

In one embodiment, the (C) polyether-ester-amide block copolymer may comprise 10 to about 95 wt % of a polyether-ester block based on 100 wt % of the polyether-ester-amide block copolymer. Within this range, the thermoplastic resin composition can exhibit good electrical conductivity, heat resistance, and the like.

In one embodiment, the (C) polyether-ester-amide block copolymer may be present in an amount of 3 to 15 parts by weight, for example, 5 to 10 parts by weight or more, for example, 5 to 8 parts by weight or less, relative to 100 parts by weight of the base resin. Within this range of the (C) polyether-ester-amide block copolymer, the thermoplastic resin composition and a molded product manufactured therefrom can exhibit good electrical conductivity while maintaining good property balance.

### (D) Maleic Anhydride-Aromatic Vinyl-Vinyl Cyanide Copolymer

In one embodiment, the (D) maleic anhydride-aromatic vinyl-vinyl cyanide copolymer serves to maintain a suitable level of property balance of the thermoplastic resin composition and a molded article manufactured therefrom. Specifically, the (D) maleic anhydride-aromatic vinyl-vinyl cyanide copolymer can maintain good properties (for example, impact resistance and the like) of the thermoplastic resin composition, which can be deteriorated upon addition of the (C) polyether-ester-amide block copolymer.

In one embodiment, the (D) maleic anhydride-aromatic vinyl-vinyl cyanide copolymer may be prepared through polymerization of a monomer mixture comprising maleic anhydride, an aromatic vinyl compound and a vinyl cyanide compound by a typical polymerization method, such as suspension polymerization, solution polymerization, bulk polymerization, and the like.

The aromatic vinyl compound may be selected from the group consisting of styrene, α-methyl styrene, p-methyl styrene, p-t-butyl styrene, 2,4-dimethyl styrene, chlorostyrene, vinyl toluene, vinyl naphthalene, and mixtures thereof.

The vinyl cyanide compound may be selected from the group consisting of acrylonitrile, methacrylonitrile, fumaronitrile, and mixtures thereof.

The (D) maleic anhydride-aromatic vinyl-vinyl cyanide copolymer may be present in any copolymerization form and may have a structure in which a maleic anhydride-derived component, an aromatic vinyl compound-derived component and a vinyl cyanide compound-derived component constitute an alternating copolymer, a random copolymer, or a block copolymer, or a structure in which the maleic anhydride-derived component is grafted to a main chain to which the aromatic vinyl compound-derived component and the vinyl cyanide compound-derived component are copolymerized.

In one embodiment, the (D) maleic anhydride-aromatic vinyl-vinyl cyanide copolymer may be a maleic anhydride-styrene-acrylonitrile copolymer.

The (D) maleic anhydride-aromatic vinyl-vinyl cyanide copolymer may comprise 2 to 15 wt % of the maleic anhydride-derived component, 50 to 90 wt % of the aromatic vinyl compound-derived component, and 5 to 40 wt % of the vinyl cyanide compound-derived component, based on 100 wt %. In one embodiment, the maleic anhydride-derived component may be present in an amount of 2 to 15 wt %, for example, 5 to 15 wt %, for example, 5 to 10 wt %, based on 100 wt % of the (D) maleic anhydride-aromatic vinyl-vinyl cyanide copolymer. Within this range of the maleic anhydride-aromatic vinyl-vinyl cyanide copolymer, the thermoplastic resin composition and a molded article manufactured therefrom can exhibit good impact resistance and/or heat resistance.

The (D) maleic anhydride-aromatic vinyl-vinyl cyanide copolymer may have a weight average molecular weight of 30,000 to 200,000 g/mol. Within this range, the thermoplastic resin composition can exhibit good impact resistance and fluidity.

In one embodiment, the (D) maleic anhydride-aromatic vinyl-vinyl cyanide copolymer may be present in an amount of 1 to 10 parts by weight, for example, 1 to 9 parts by weight, for example, 1 to 8 parts by weight, for example, 1 to 7 parts by weight, for example, 1 to 6 parts by weight, for example, 1 to 5 parts by weight, relative to 100 parts by weight of the base resin. Within this content range of the (D) maleic anhydride-aromatic vinyl-vinyl cyanide copolymer, the thermoplastic resin composition and a molded article manufactured therefrom can exhibit good electrical conductivity while maintaining good property balance.

### (E) Calcium Stearate

In one embodiment, the (E) calcium stearate improves paint adhesion of the thermoplastic resin composition. In particular, when a molded article manufactured from the thermoplastic resin composition is painted and exposed to a harsh environment of high temperature/high humidity for a long period of time, blistering can occur on the surface of the painted molded article, causing significant deterioration in paint adhesion.

However, the thermoplastic resin composition according to one embodiment comprises 0.1 to 1 part by weight of the (E) calcium stearate relative to 100 parts by weight of the base resin, whereby the molded article can suffer from no blistering and little change in paint adhesion even when exposed to a high temperature/humid harsh environment for a long period of time after painting.

The (E) calcium stearate may be present in an amount of 0.1 to 1 part by weight, for example, 0.2 to 0.7 parts by weight, for example, 0.2 to 0.5 parts by weight, relative to 100 parts by weight of the base resin. Within these ranges, the thermoplastic resin composition can exhibit good paint adhesion while maintaining property balance.

### (F) Additive

In addition to the components (A) to (E), the thermoplastic resin composition according to one embodiment may further comprise at least one type of additive in order to secure property balance while securing good properties in terms of electrical conductivity and paint adhesion, or according to final purpose of the thermoplastic resin composition, as needed.

Specifically, the additives may include nucleating agents, coupling agents, fillers, plasticizers, lubricants, release agents, antibacterial agents, heat stabilizers, antioxidants, UV stabilizers, flame retardants, colorants, impact modifiers, and the like. These may be used alone or in combination thereof.

These additives may be present in a suitable amount within the range not causing deterioration in properties of the thermoplastic resin composition, specifically in an amount of 20 parts by weight or less relative to 100 parts by weight of the base resin, without being limited thereto.

The thermoplastic resin composition according to the present invention may be prepared by a typical method in the art.

For example, the thermoplastic resin composition according to the present invention may be prepared in pellet form by simultaneously mixing the aforementioned components of the present invention and other additives, followed by melting/kneading in an extruder.

Another embodiment of the present invention provides a molded article manufactured from the thermoplastic resin composition described above. For example, the molded article may be manufactured by various methods known in the art, such as injection molding, extrusion molding, and the like, without being limited thereto.

In one embodiment, the molded article may have a notched Izod impact strength of 20 to 60 kgf·cm/cm, for example, 30 to 50 kgf·cm/cm, for example, 40 to 50 kgf·cm/cm, as measured on a ¼″ thick specimen in accordance with ASTM D256.

In one embodiment, the molded article may have a surface resistance of 10^{11.0} Ω/sq or less, for example, 10^{10.9} Ω/sq or less, for example, 10^{10.8} Ω/sq or less, for example, 10^{10.7} Ω/sq or less, as measured on a specimen having a size of 100 mm×100 mm×20 mm using a surface resistance meter (Manufacturer: SIMCO-ION, Model: ST-4).

As such, the thermoplastic resin composition and a molded article using the same exhibit good electrical conductivity and property balance, particularly good paint adhesion without a blistering phenomenon even when exposed to a harsh environment of high temperature/high humidity for a long period of time after electrostatic painting, and can be widely applied to various products used for painting and non-painting, particularly to molded articles for painting that require electrostatic painting.

Next, the present invention will be described in more detail with reference to some examples. It should be understood that these examples are provided for illustration only and are not to be in any way construed as limiting the invention.

### Examples 1 and 2 and Comparative Examples 1 to 8

Thermoplastic compositions of Examples 1 and 2 and Comparative Examples 1 to 8 were prepared according to the content ratios, as listed in Table 1 below.

In Table 1, (A) and (B) are included in a base resin and are expressed by wt % based on the total weight of the base resin, and (C), (D) and (E) are added to the base resin and are expressed by parts by weight relative to 100 parts by weight of the base resin.

The above components were dry mixed in amounts as listed in Table 1, quantitatively and continuously injected into a feeder of a twin-screw extruder (L/D-44, Φ=45 mm), and subjected to melting/kneading at about 250° C., thereby preparing pellets. Then, the pellets of the thermoplastic resin composition were dried at about 80° C. for 4 hours and injection-molded in a 120-ton injection molding machine with a cylinder temperature of about 240° C. and a mold temperature of about 60° C., thereby preparing specimens for property evaluation.

TABLE 1

| | Example | | Comparative Example | | | | | | | |
|---|---|---|---|---|---|---|---|---|---|---|
| | 1 | 2 | 1 | 2 | 3 | 4 | 5 | 6 | 7 | 8 |
| (A) | 85 | 85 | 85 | 85 | 85 | 100 | 85 | 85 | 85 | 85 |
| (B) | 15 | 15 | 15 | 15 | 15 | — | 15 | 15 | 15 | 15 |
| (C) | 8 | 8 | 8 | — | 8 | 8 | 8 | 8 | 8 | 8 |
| (D) | 4 | 4 | 4 | 4 | — | 4 | 4 | 4 | 4 | 4 |
| (E) | 0.2 | 0.5 | — | 0.5 | 0.5 | 0.5 | — | — | — | — |
| (E1) | — | — | — | — | — | — | 0.5 | — | — | — |
| (E2) | — | — | — | — | — | — | — | 0.5 | — | — |
| (E3) | — | — | — | — | — | — | — | — | 0.5 | — |
| (E4) | — | — | — | — | — | — | — | — | — | 0.5 |

The components listed in Table 1 are as follows.

### (A) Butadiene Rubber Modified Aromatic Vinyl-Vinyl Cyanide Copolymer Resin

Acrylonitrile-butadiene-styrene graft copolymer (Lotte Chemical Co., Ltd.) comprising about 30 wt % of an acrylonitrile-butadiene-styrene graft copolymer dispersed phase, which comprises about 58 wt % of a core (average particle diameter: about 0.25 μm) composed of a butadiene rubber polymer and a shell formed by graft polymerization of acrylonitrile and styrene (acrylonitrile:styrene=about 2.5:7.5 (weight ratio)) to the core, and about 70 wt % of an styrene-acrylonitrile copolymer continuous phase comprising about 28 wt % of an acrylonitrile derived component and having a weight average molecular weight of about 120,000 g/mol

### (B) Polyamide Resin

Polyamide 6 having a melting point of about 223° C. and a relative viscosity of about 2.3 (EN-300, KP ChemTech Co., Ltd.)

### (C) Polyether-Ester-Amide Block Copolymer

Polyamide 6-polyethylene oxide block copolymer (PA6-b-PEO, Sanyo Co., Ltd., PELECTRON AS)

### (D) Maleic Anhydride-Aromatic Vinyl-Vinyl Cyanide Copolymer

Maleic anhydride-styrene-acrylonitrile (SAM-010, Sunny FC)

### (E) Calcium Stearate

Songstab Ca-ST (Songwon Industry Co., Ltd.)

### (E1) Magnesium Stearate

Songstab SM-310 (Songwon Industry Co., Ltd.)

### (E2) Montane Wax

Licowax O (Clariant Co., Ltd.)

### (E3) Fatty Acid Ester

Unister H-476 (NOF Co., Ltd.)

### (E4) Oxidized Polyethylene Wax

Licowax PED 191 (Clariant Co., Ltd.)

### EXPERIMENTAL EXAMPLE

Experimental results are shown in Table 2.
(1) Electrical conductivity (unit: Ω/sq): Surface resistance was measured on a specimen having a size of 100 mm×100 mm×20 mm using a surface resistance meter (Manufacturer: SIMCO-ION, Model: ST-4). Lower surface resistance indicates better electrical conductivity.
(2) Impact resistance (unit: kgf·cm/cm): Notched Izod impact strength was measured on a ¼″ thick specimen in accordance with ASTM D256.
(3) Evaluation of blistering phenomenon

After painting a specimen having a size of 100 mm×100 mm×20 mm with a KCC two-component paint for electrostatic painting, the painted specimen was completely dipped in a water bath filled with water at 40° C. for 10 days. Then, the specimen was removed from the bath, dried, and visually observed for blistering on the surface of the specimen.

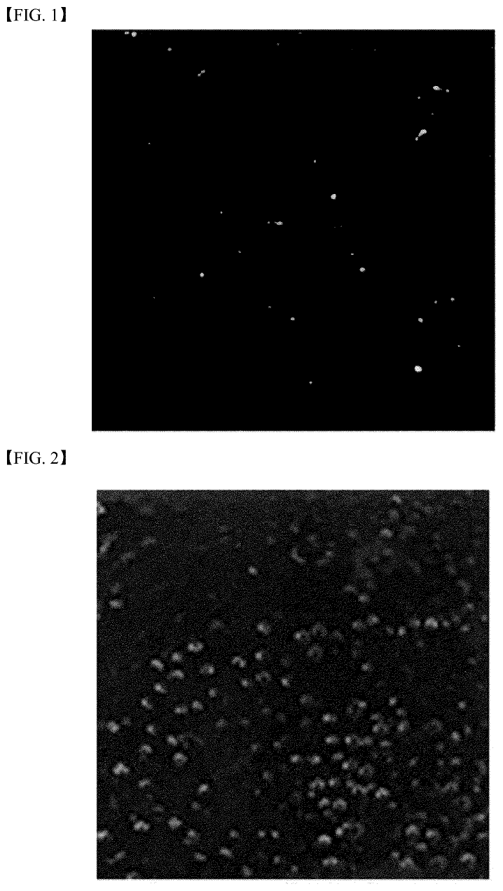

Photographs used to evaluate the blistering phenomenon of the molded articles of Example 1 and Comparative Example 1 are shown in FIG. 1 and FIG. 2, respectively.
(4) Evaluation of paint adhesion

After painting a specimen having a size of 100 mm×100 mm×20 mm with a KCC two-component paint for electrostatic painting, the painted specimen was completely dipped in a water bath filled with water at 40° C. for 10 days. Then, the specimen was removed from the bath, dried, and evaluated as to paint adhesion in accordance with ASTM D3359. (Paint adhesion was rated by six grades from 0B to 5B, with 5B being the highest grade.)

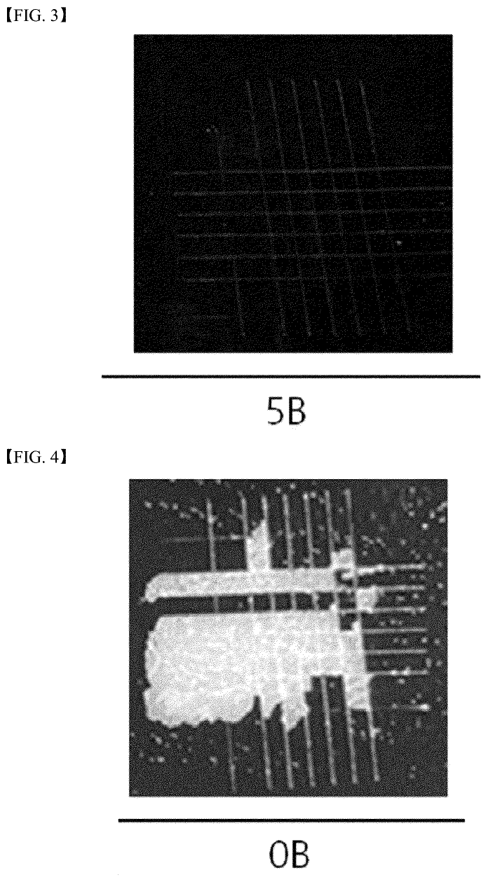

Photographs used to evaluate paint adhesion of the molded articles of Example 1 and Comparative Example 1 are shown in FIG. 3 and FIG. 4, respectively.

TABLE 2

| | Example | | Comparative Example | | | | | | | |
|---|---|---|---|---|---|---|---|---|---|---|
| | 1 | 2 | 1 | 2 | 3 | 4 | 5 | 6 | 7 | 8 |
| Surface | 109.9 | 109.8 | 109.5 | 1013.5 | 109.8 | 1012.8 | 109.9 | 109.8 | 1010.0 | 109.9 |
| resistance | | | | | | | | | | |
| Izod impact | 42 | 43 | 35 | 6 | 18 | 32 | 35 | 40 | 38 | 35 |
| resistance | | | | | | | | | | |
| Blistering | No | No | Occur | No | Occur | No | Occur | Occur | Occur | Occur |
| Paint adhesion | 5B | 4B | 0B | 1B | 0B | 3B | 1B | 1B | 0B | 0B |

From Tables 1 and 2 and FIG. 1 to FIG. 4, it can be seen that a thermoplastic resin composition comprising a butadiene rubber modified aromatic vinyl-vinyl cyanide copolymer resin, a polyamide resin, a polyether-ester-amide block copolymer, a maleic anhydride-aromatic vinyl-vinyl cyanide copolymer, and calcium stearate in optimal amounts can be used to provide a thermoplastic resin composition and a molded article using the same that exhibit good properties in terms of electrical conductivity, impact resistance, and paint adhesion, as compared to comparative examples.

In particular, the molded article of Example 1 did not suffer from blistering and exhibited good paint adhesion of 5B, as shown in FIG. 1 and FIG. 3, whereas the molded article of Comparative Example 1 not containing any calcium stearate had multiple blisters and exhibited poor paint adhesion of 0B, as shown in FIG. 2 and FIG. 4.

In addition, since the molded articles of Comparative Examples 5 to 8 contain substances other than the (E) calcium stearate according to the present invention, these molded articles suffered from blistering and exhibited very low paint adhesion. Accordingly, it can be seen that the (E) calcium stearate of the present invention does not cause blistering on the surface of the paint molded article and maintains good paint adhesion even in a harsh environment of high temperature/high humidity for a long period of time.

Although some exemplary embodiments have been described above, it should be understood that the present invention is not limited thereto and various modifications, changes, alterations, and equivalent embodiments can be made by those skilled in the art without departing from the spirit and scope of the invention.

1. A thermoplastic resin composition comprising, relative to 100 parts by weight of a base resin comprising 70 to 95 wt % of (A) a butadiene rubber modified aromatic vinyl-vinyl cyanide copolymer resin and 5 to 30 wt % of (B) a polyamide resin,
3 to 15 parts by weight of (C) a polyether-ester-amide block copolymer;
1 to 10 parts by weight of (D) a maleic anhydride-aromatic vinyl-vinyl cyanide copolymer; and
0.1 to 1 part by weight of (E) calcium stearate.

2. The thermoplastic resin composition according to claim 1, wherein the (A) butadiene rubber modified aromatic vinyl-vinyl cyanide copolymer resin comprises a butadiene rubber modified aromatic vinyl-vinyl cyanide copolymer dispersed phase having a core-shell structure in which a core is composed of a butadiene rubber polymer and a shell is formed by graft polymerization of an aromatic vinyl compound and a vinyl cyanide compound to the core, and an aromatic vinyl-vinyl cyanide copolymer continuous phase, and the butadiene rubber polymer has an average particle diameter of 0.2 μm to 1.0 μm.

3. The thermoplastic resin composition according to claim 2, wherein the (A) butadiene rubber modified aromatic vinyl-vinyl cyanide copolymer resin comprises 10 to 40 wt % of the butadiene rubber modified aromatic vinyl-vinyl cyanide copolymer dispersed phase and 60 to 90 wt % of the aromatic vinyl-vinyl cyanide copolymer continuous phase, based on 100 wt % of the (A) butadiene rubber modified aromatic vinyl-vinyl cyanide copolymer resin.

4. The thermoplastic resin composition according to claim 2, wherein the aromatic vinyl-vinyl cyanide copolymer comprises 60 to 80 wt % of an aromatic vinyl compound-derived component and 20 to 40 wt % of a vinyl cyanide compound-derived component.

5. The thermoplastic resin composition according to claim 2, wherein the (A) butadiene rubber modified aromatic vinyl-vinyl cyanide copolymer resin is an acrylonitrile-butadiene-styrene copolymer resin comprising an acrylonitrile-butadiene-styrene graft copolymer dispersed phase and an acrylonitrile-styrene copolymer continuous phase.

6. The thermoplastic resin composition according to claim 1, wherein the (B) polyamide resin comprises polyamide 6, polyamide 66, polyamide 46, polyamide 11, polyamide 12, polyamide 610, polyamide 612, polyamide 6I, polyamide 6T, polyamide 4T, polyamide 410, polyamide 510, polyamide 1010, polyamide 1012, polyamide 10T, polyamide 1212, polyamide 12T, polyamide MXD6, or a combination thereof.

7. The thermoplastic resin composition according to claim 6, wherein the polyamide resin comprises polyamide 6.

8. The thermoplastic resin composition according to claim 1, wherein the (C) polyether-ester-amide block copolymer is a reaction product of an aminocarboxylic acid having 6 or more carbon atoms, a lactam, or a salt of diamine-dicarboxylic acid; a polyalkylene glycol; and a dicarboxylic acid having 4 to 20 carbon atoms.

9. The thermoplastic resin composition according to claim 1, wherein the (D) maleic anhydride-aromatic vinyl-vinyl cyanide copolymer comprises 2 to 15 wt % of a maleic anhydride-derived component based on 100 wt % of the maleic anhydride-aromatic vinyl-vinyl cyanide copolymer.

10. The thermoplastic resin composition according to claim 1, wherein the (D) maleic anhydride-aromatic vinyl-vinyl cyanide copolymer is a maleic anhydride-styrene-acrylonitrile copolymer.

11. The thermoplastic resin composition according to claim 1, wherein the (E) calcium stearate is present in an amount of 0.2 to 0.7 parts by weight relative to 100 parts by weight of the base resin.

12. The thermoplastic resin composition according to claim 1, further comprising:
at least one additive selected from among a nucleating agent, a coupling agent, a filler, a plasticizer, a lubricant, a release agent, an antibacterial agent, a heat stabilizer, an antioxidant, an ultraviolet stabilizer, a flame retardant, a colorant, and an impact modifier.

13. A molded article manufactured from the thermoplastic resin composition according to claim 1.

14. The molded article according to claim 13, wherein the molded article has a notched Izod impact strength of 20 to 60 kgf·cm/cm, as measured on a ¼″ thick specimen in accordance with ASTM D256.

15. The molded article according to claim 13, wherein the molded article has a surface resistance of 10^{11.0} Ω/sq or less, as measured on a specimen having a size 100 mm×100 mm×2 mm using a surface resistance meter (Manufacturer: SIMCO-ION, Model: ST-4).
